(19) United States
(12) Patent Application Publication
(10) Pub. No.: US 2011/0193858 A1
(43) Pub. Date: Aug. 11, 2011

(54) METHOD FOR DISPLAYING IMAGES USING AN ELECTRONIC DEVICE

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/756,983

(22) Filed: Apr. 8, 2010

(30) Foreign Application Priority Data
Feb. 8, 2010 (CN) 201010301330.6

(51) Int. Cl. G06T 15/10

(52) U.S. Cl. 345/419

(57) ABSTRACT

A method for displaying images using an electronic device sets a virtual three dimension (3D) image of an object, and stores the virtual 3D image in a storage device of the electronic device. The method further obtains a movement direction and a movement angle of the electronic device by a G-Sensor of the electronic device, rotates the virtual 3D image of the object according to the movement direction and the movement angle of the electronic device, and displays the rotated image of the object on a display device of the electronic device.

### BACKGROUND

1. Technical Field

Embodiments of the present disclosure relate to image display technology, and particularly to a method for displaying images using an electronic device.

2. Description of Related Art

Currently, images of an object (e.g., product catalogs) may be displayed on a display screen of an electronic device statically. Status of the images cannot be changed according to a movement of the electronic device. Therefore, an improved and efficient method for displaying the images is desired.

### BRIEF DESCRIPTION OF THE DRAWINGS

FIG. 1 is a block diagram of one embodiment of an electronic device.

FIG. 2 is a flowchart of a first exemplary embodiment of a method for displaying images using the electronic device in FIG. 1.

FIG. 3 is a flowchart of a second exemplary embodiment of a method for displaying images using the electronic device in FIG. 1.

### DETAILED DESCRIPTION

All of the processes described below may be embodied in, and fully automated via, functional code modules executed by one or more general purpose computers or processors. The code modules may be stored in any type of readable medium or other storage device. Some or all of the methods may alternatively be embodied in specialized hardware. Depending on the embodiment, the readable medium may be a hard disk drive, a compact disc, a digital video disc, or a tape drive.

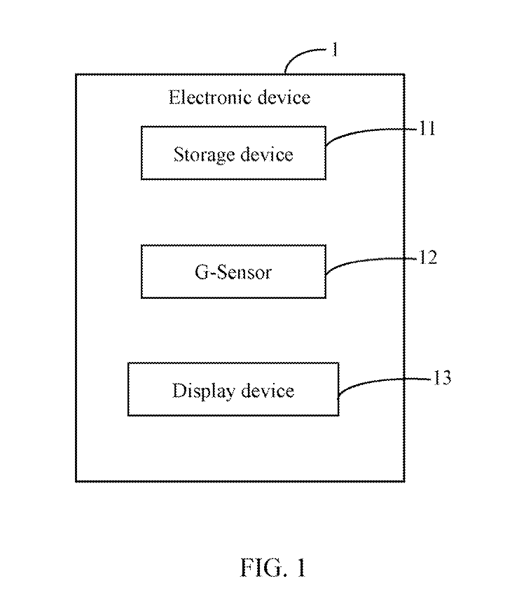

FIG. 1 is a block diagram of one embodiment of an electronic device 1. In one embodiment, the electronic device 1 includes a storage device 11, a G-Sensor 12, and a display device 13. In one embodiment, the electronic device 1 may be used to display images according to a movement of the electronic device 1. The storage device 11 may store various information, such as images of an object at different angles and a virtual three dimension (3D) of the object, for example. The G-Sensor 12 may obtain a movement direction and a movement angle of the electronic device 1. In one embodiment, the electronic device 1 may be an electronic book, a cell phone, a digital camera, or a personal digital assistant (PDA).

In one embodiment, the display device 13 may display electronic texts and images in the electronic device 1. Depending on the embodiment, the display device 1 may be a liquid crystal display (LCD) or a cathode ray tube (CRT) display, for example.

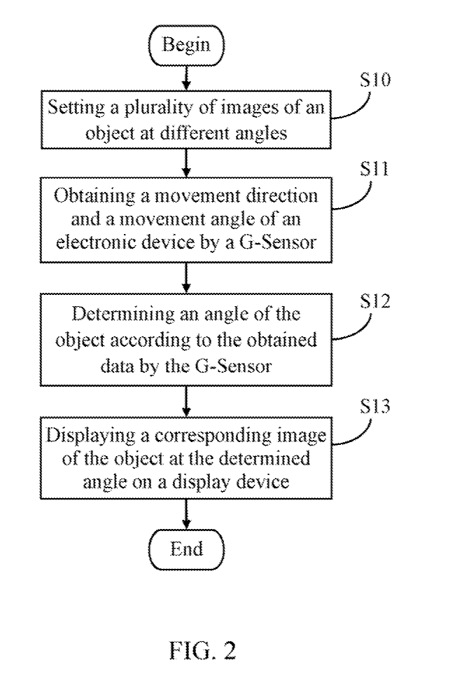

FIG. 2 is a flowchart of a first exemplary embodiment of a method for displaying images using the electronic device 1 in FIG. 1.

In block S10, a plurality of images of an object at different angles are set, and the plurality of images are stored in the storage device 11 of the electronic device 1. In one embodiment, the plurality of images are set using a multimedia platform for creating animation and interactivity, such as Adobe Flash. In another embodiment, the plurality of images may be set using a 3D software tool, such as the Google SketchUp and Maya.

In block S11, the G-Sensor 12 obtains a movement direction and a movement angle of the electronic device 1.

In block S12, the electronic device 1 determines an angle of the object according to the movement direction and the movement angle of the electronic device 1. A detailed description is provided as follows.

In one embodiment, if the movement direction of the electronic device 1 is left, the electronic device 1 rotates an image of the object rightward according to the movement angle of the electronic device 1, so as to determine an angle of the object. In one embodiment, the rotating angle of the image is greater than the movement angle of the electronic device 1. For example, if the movement angle of the electronic device 1 is 1 degree, the rotating angle of the image may be 6 degrees. If the movement angle of the electronic device 1 is 30 degrees, the rotating angle of the image may be 180 degrees.

If the movement direction of the electronic device 1 is right, the electronic device 1 rotates an image of the object leftward according to the movement angle of the electronic device 1, so as to determine an angle of the object.

If the movement direction of the electronic device 1 is up, the electronic device 1 rotates an image of the object downward according to the movement angle of the electronic device 1, so as to determine an angle of the object.

If the movement direction of the electronic device 1 is down, the electronic device 1 rotates an image of the object upward according to the movement angle of the electronic device 1, so as to determine an angle of the object.

In block S13, the electronic device 1 obtains a corresponding image of the object at the determined angle from the storage device 11, and displays the obtained image on the display device 13.

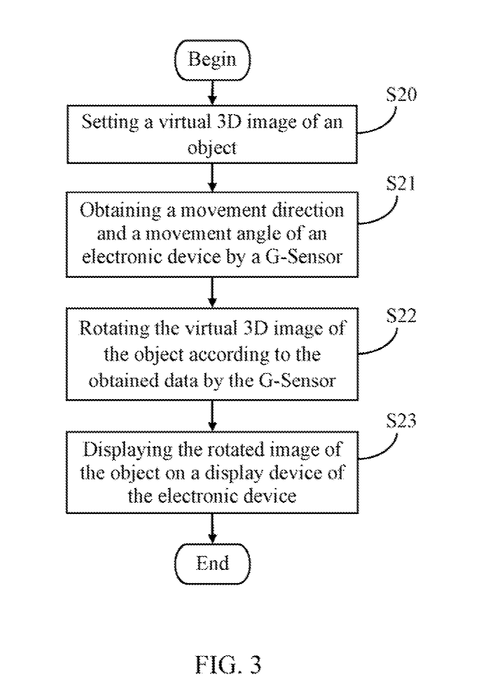

FIG. 3 is a flowchart of a second exemplary embodiment of a method for displaying images using the electronic device 1 in FIG. 1.

In block S20, a virtual 3D image of an object is set, and the virtual 3D image is stored in the storage device 11 of the electronic device 1. In one embodiments, the virtual 3D image is set using a 3D software tool, such as the Google SketchUp and Maya. A detailed description is as follows. Firstly, an outline of the object is drawn using the 3D software tool. Secondly, a rendering operation is performed on the outline of the object so as to obtain the virtual 3D image of the object.

In block S21, the G-Sensor 12 obtains a movement direction and a movement angle of the electronic device 1.

In block S22, the electronic device 1 rotates the virtual 3D image of the object according to the movement direction and the movement angle of the electronic device 1. A detailed description is provided as follows.

For example, if the movement direction of the electronic device 1 is left, the electronic device 1 rotates the virtual 3D image of the object rightward according to the movement angle of the electronic device 1. In one embodiment, the rotating angle of the virtual 3D image is greater than the movement angle of the electronic device 1.

If the movement direction of the electronic device 1 is right, the electronic device 1 rotates the virtual 3D image of the object leftward according to the movement angle of the electronic device 1.

If the movement direction of the electronic device 1 is up, the electronic device 1 rotates the virtual 3D image of the object downward according to the movement angle of the electronic device 1.

If the movement direction of the electronic device 1 is down, the electronic device 1 rotates the virtual 3D image of the object upward according to the movement angle of the electronic device 1.

In block S23, the electronic device 1 displays the rotated image of the object on the display device 13.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for displaying images using an electronic device, the method comprising:
setting a plurality of images of an object at different angles, and storing the plurality of images in a storage device of the electronic device;
obtaining a movement direction and a movement angle of the electronic device by a G-Sensor of the electronic device;
determining an angle of the object according to the movement direction and the movement angle of the electronic device; and
obtaining a corresponding image of the object at the determined angle from the storage device, and displaying the obtained image on a display device of the electronic device.

2. The method according to claim 1, wherein the plurality of images are set using a multimedia platform.

3. The method according to claim 1, wherein the plurality of images are set using a three dimension (3D) software tool.

4. The method according to claim 1, wherein the step of determining an angle of the object according to the movement direction and the movement angle of the electronic device comprises:
rotating an image of the object rightward according to the movement angle of the electronic device if the movement direction of the electronic device is left, to determine the angle of the object;
rotating an image of the object leftward according to the movement angle of the electronic device if the movement direction of the electronic device is right, to determine the angle of the object;
rotating an image of the object downward according to the movement angle of the electronic device if the movement direction of the electronic device is up, to determine the angle of the object; or
rotating an image of the object upward according to the movement angle of the electronic device if the movement direction of the electronic device is down, to determine the angle of the object.

5. The method according to claim 4, wherein the rotating angle of the image is greater than the movement angle of the electronic device.

6. The method according to claim 1, wherein the electronic device is selected from the group comprising an electronic book, a cell phone, a digital camera, and a personal digital assistant (PDA).

7. A method for displaying images using an electronic device, the method comprising:
setting a virtual three dimension (3D) image of an object, and storing the virtual 3D image in a storage device of the electronic device;
obtaining a movement direction and a movement angle of the electronic device by a G-Sensor of the electronic device;
rotating the virtual 3D image of the object according to the movement direction and the movement angle of the electronic device; and
displaying the rotated image of the object on a display device of the electronic device.

8. The method according to claim 7, wherein the step of setting a virtual three dimension (3D) image of an object comprises:
drawing an outline of the object using a 3D software tool; and
performing a rendering operation on the outline of the object to obtain the virtual 3D image of the object.

9. The method according to claim 7, wherein the step of rotating the virtual 3D image of the object according to the movement direction and the movement angle of the electronic device comprises:
rotating the virtual 3D image of the object rightward according to the movement angle of the electronic device if the movement direction of the electronic device is left;
rotating the virtual 3D image of the object leftward according to the movement angle of the electronic device if the movement direction of the electronic device is right;
rotating the virtual 3D image of the object downward according to the movement angle of the electronic device if the movement direction of the electronic device is up; or
rotating the virtual 3D image of the object upward according to the movement angle of the electronic device if the movement direction of the electronic device is down.

10. The method according to claim 9, wherein the rotating angle of the virtual 3D image is greater than the movement angle of the electronic device.

11. The method according to claim 7, wherein the electronic device is selected from the group comprising an electronic book, a cell phone, a digital camera, and a personal digital assistant (PDA).
